(19) United States
(12) Patent Application Publication
(10) Pub. No.: US 2007/0266390 A1
(43) Pub. Date: Nov. 15, 2007

(54) Automated management of application-specific tasks from the Internet via distributed task manager agents in a local area network

(76) Inventor: Mark Emmerich, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,344

(22) Filed: Oct. 31, 2006

Related U.S. Application Data
(63) Continuation-in-part of application No. 11/263,712, filed on Oct. 31, 2005.

(51) Int. Cl. G06F 9/46

(52) U.S. Cl. 718/105

(57) ABSTRACT

Described is automated distributed management in a local area network of application tasks downloaded from the Internet an automatic task manager software agent operating on a network node in the local area network. An automatic task manager software agent is also communicatively coupled via the Internet for downloading at least one policy with a scheduled task from an application service and generating a task result file for the at least one policy. The automatic task manager has access to a memory including a policy database accessible to the automatic task manager for storing the at least one downloaded policy, and a storage module for storing the at least one task result file. The automatic task manager can also periodically perform an entitlement check for verifying whether a user has rights to run a current installation of an application.

### CROSS REFERENCE TO RELATED APPLICATION

This application claims priority as a continuation-in-part of U.S. pending patent application Ser. No. 11/263,712 entitled “Discovery of and Sharing of Content Within a Sharing Neighborhood of a Network,” having common inventors and which is incorporated by reference into this patent application.

### BACKGROUND

1. Field of the Invention

The present invention generally relates to managing application-specific scheduled tasks in a network of computers, particularly in a network of desktop computers.

Most computers come equipped with a (OS) platform-supplied task scheduler. This task scheduler can be manipulated locally by a privileged user (or application), or by more sophisticated systems management software (e.g., Microsoft SMS solution). To revise a particular task's schedule, either the end-user must perform some administrative action, or the company's IT department must manipulate the task configuration via their management console.

Maintaining a coherent operating schedule across all managed desktops requires a great effort on the part of the IT staff whenever there is a change. The IT staff must manipulate each computer's configuration to accommodate the revisions. For those smaller companies that lack the resources and infrastructure needed for a system management solution, the burden of managing the regularly scheduled tasks falls upon each end user. This can lead to errors introduced by the end users or simply out-of-date configurations and task schedules.

Furthermore, some applications provide a service for a recurring fee. If the fee should go unpaid, or the subscription canceled, there is no way to automatically revise the list of scheduled tasks to exclude the fee-based service's tasks. Just as difficult is the need to re-enable those scheduled tasks once the service fee has been paid. Since the manual effort to reconfigure each system when the fee expires is placed on the end-user or customer's IT support staff, the work of disabling the scheduled tasks is usually skipped in the interest of conserving manpower.

A solution for distributed local management of regularly scheduled tasks downloaded via the Internet is highly desirable.

### SUMMARY

The present invention provides one or more embodiments of a solution for automated distributed management in a local area network of applications tasks downloaded from the Internet.

A system for automated distributed management in a local area network of applications tasks downloaded from the Internet in accordance with an embodiment of the present invention comprises an automatic task manager software agent operating on a network node in the local area network. The automatic task manager software agent is also communicatively coupled via the Internet for downloading at least one policy with a scheduled task from an application service and generating a task result file for the at least one policy. The automatic task manager has access to a memory including a policy database accessible to the automatic task manager for storing the at least one downloaded policy, and a storage module for storing the at least one task result file.

In one embodiment, the automatic task manager periodically performs an entitlement check for verifying whether a user has rights to run a current installation of an application. The at least one downloaded policy further comprises a sequence of steps to disable an application when an entitlement check fails, and a sequence of steps to re-enable an application when an entitlement check validates entitlement has been restored.

A method for automated distributed management in a local area network of applications tasks downloaded from the Internet in accordance with an embodiment of the present invention comprises automatically determining at a predetermined time whether a new or update policy is available from an application service via the Internet. For example, the time that the policy-check is performed can be selected by a downloaded task manager agent based on a random number generator when the application is first installed. Responsive to a new policy being available, downloading the new policy into a local policy database, and responsive to an updated policy being available, downloading the updated policy and replacing any scheduled task associated with an earlier version of the updated policy with the tasks of the updated policy.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is an architectural block diagram of system for automated distributed management in a local area network of applications tasks downloaded from the Internet operating within a computer system in accordance with an embodiment of the present invention.

FIG. 2A is a flow diagram of a method for automated distributed management in a local area network of applications tasks downloaded from the Internet in accordance with an embodiment of the present invention.

FIG. 2B is a continuation of the flow diagram of the method embodiment of FIG. 2A.

FIG. 3 is a flow diagram of a method for automated distributed management in a local area networks of entitlement to an application in accordance with a policy downloaded from the Internet in accordance with an embodiment of the present invention.

FIG. 4 illustrates examples of different bandwidth consumption rates for a number of download speeds in accordance with an embodiment of the present invention.

FIG. 5 illustrates an implementation example of a system for automated distributed management in a local area network of application tasks downloaded from the Internet comprising a first executable operating as a system service and a second executable operating in user space in accordance with an embodiment of the present invention.

FIG. 6 illustrates an example display for notifying an end user about a task result in accordance with an embodiment of the present invention.

FIG. 7 illustrates an example of a policy file format 700 that can be used in one or more embodiments of the present invention.

The figures depict embodiments of the present invention for purposes of illustration only. One skilled in the art will readily recognize from the following discussion that other embodiments of the structures and methods illustrated herein may be employed without departing from the principles of the invention described herein.

### DETAILED DESCRIPTION OF THE DRAWINGS

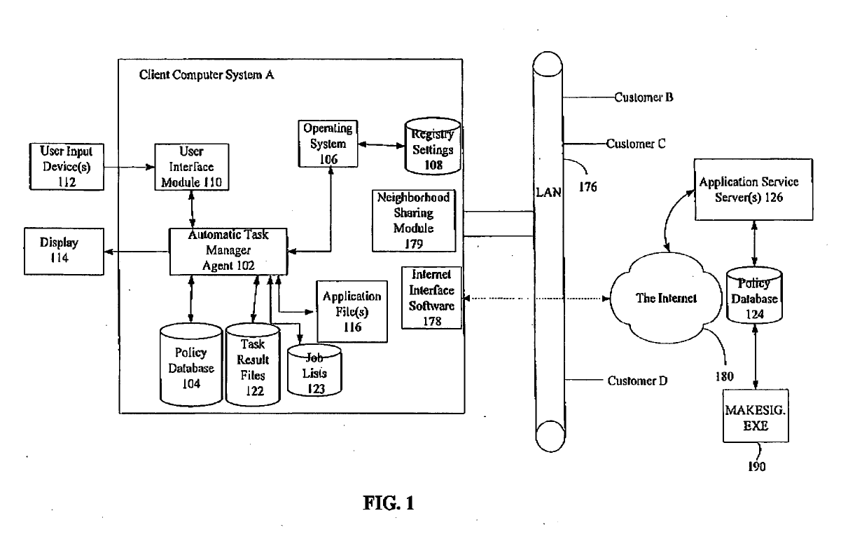

FIG. 1 is an architectural block diagram of system for automated distributed management in a local area network of applications tasks downloaded from the Internet operating within a computer system in accordance with an embodiment of the present invention. The system embodiment operates in an example context of a service customer's local area network 176 including a plurality of client computer systems A, B, C, and D. Client computer system A is enlarged to illustrate a representative system embodiment comprising an automatic task manager agent 102 communicatively coupled to one or more application(s) 116. The automatic task manager agent 102 checks at the predetermined time for each installed applications for policy downloads from one or more application service server(s) 126 having access to a policy database 124 for the application generated by the application service. In this embodiment, each policy file is “signed” to protect against tampering by a MAKESIG 190 executable module. The task manager agent 102 downloads policy files and policy-specified (application) files over the Internet on behalf of the managed applications 116. The automatic task manager software agent 102 is communicatively coupled to an operating system 106 for computer system A in order to access its registry settings 108. The automatic task manager 102 also has access to a storage module 104 (stored in the computer's memory) for policies downloaded from an application service server 126 over the Internet 180, a storage module for task result files 122 generated for launching tasks of the policies and notifying an end user of task results, and a storage module 123 for job lists associated with executing tasks.

In this embodiment, the automatic task manager agent 102 is communicatively coupled via Internet interface software 178, preferably web interface software, to the Internet 180 for obtaining downloads from an application service server 126. Additionally, the automatic task manager agent 102 is communicatively coupled to a neighborhood sharing module 179 through which it can announce that new downloads are available to other instantiations of the neighborhood sharing module on other nodes (e.g., B, C, D) in the local area network. As described more fully in U.S. patent application entitled “Discovery of and Sharing of Content Within a Sharing Neighborhood of a Network,” the neighborhood sharing module 179 shares downloads via the local area network with sharing neighbors or members in a sharing neighborhood for a specific application to cut down on Internet traffic for such updates.

The automatic task manager agent 102 is communicatively coupled to a display 114 for generating displays for communicating task results to an end user and also is communicatively coupled to one or more user input device(s) 112 via a user interface module 110 for receiving user input, in particular commands related to tasks.

Each of the modules illustrated in FIG. 1 or a portion thereof can be implemented in software suitable for execution on a processor and storage in a computer-usable medium, hardware, firmware or any combination of these. Computer-usable media include any configuration or medium capable of storing or transferring programming, data, or other digital information. Examples of computer-usable media include a data transmission as well as various memory embodiments such as random access memory and read only memory, which can take a variety of forms, some examples of which are a hard disk, a disk, flash memory, or a memory stick.

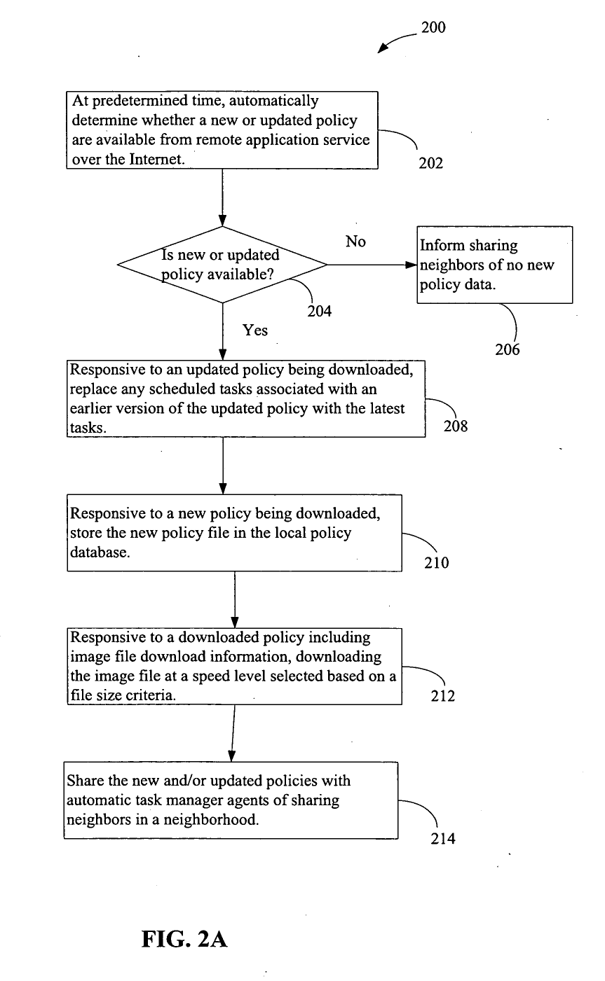

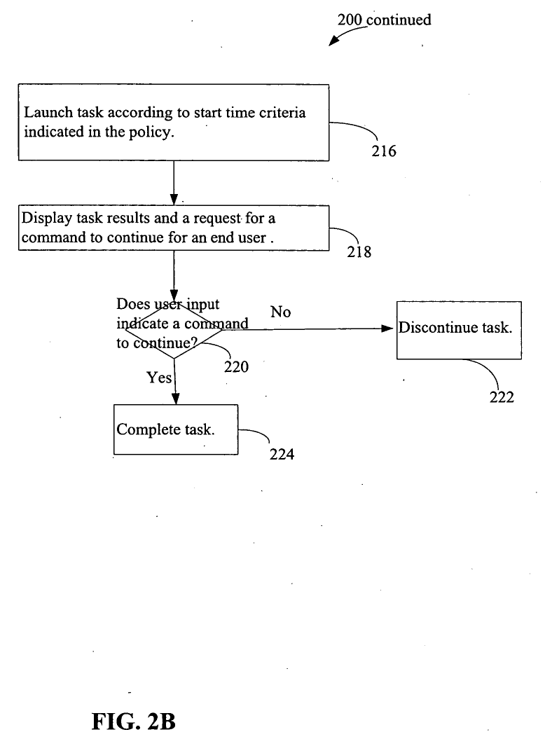

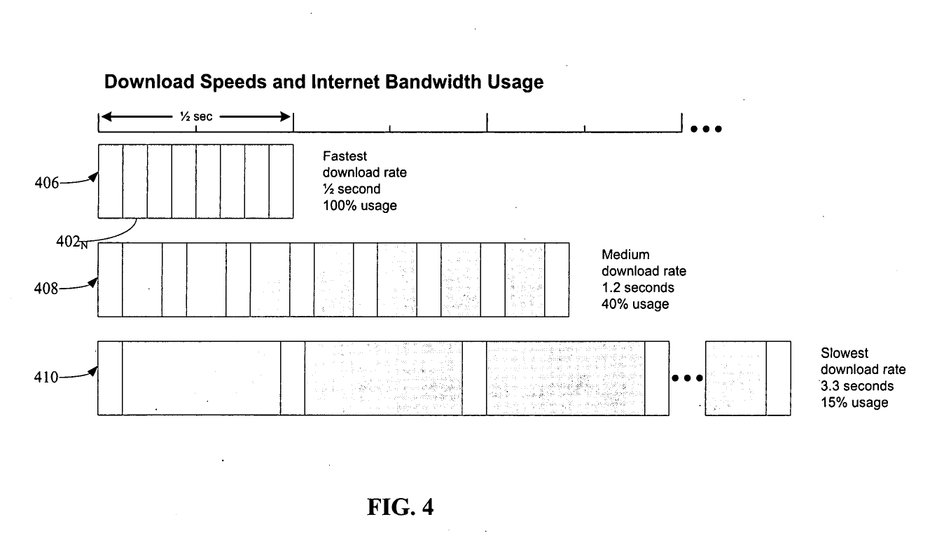

FIGS. 2A and 2B illustrate a flow diagram of a method 200 for automated distributed management in a local area network of applications tasks downloaded from the Internet in accordance with an embodiment of the present invention. For illustrative purposes only and not to be limiting thereof, the method embodiment 200 FIGS. 2A and 2B are discussed in the context of the system embodiment of FIG. 1. The automatic task manager agent 102 automatically determines 202 at a predetermined time whether a new or update policy is available from an application service via the Internet. Responsive to no new or updated policy being available, the automatic task manager agent 102 informs 206 via the neighborhood sharing module 179 sharing neighbors in a shared neighborhood for the application of no new policy data for download. Responsive to an updated policy being downloaded, the automatic task manager agent 102 replaces 208 any scheduled task associated with an earlier version of the updated policy with the latest tasks of the updated policy. Responsive to a new policy being downloaded, the automatic task manager agent 102 stores 210 the new policy into a local policy database. Responsive to a downloaded policy including image file download information, the automatic task manager agent 102 downloading 212 the image file at a speed level selected based on a file size criteria. (See discussion for FIG. 4 below.) After receiving a notification message from the automatic task manager agent 102, the neighborhood sharing module 179 sharing 214 the new policy data (e.g., new and/or updated policies and image files, if any) with automatic task manager agents of sharing neighbors in the neighborhood on the local area network via their instantiations of a neighborhood sharing module.

Continuing with FIG. 2B, the automatic task manager agent 102 launches 216 a task of the downloaded policy according to a start time criteria indicated in the policy, and displays 218 task results and a request for a command to continue for an end user. Responsive to user input indicating a command to continue, the automatic task manager agent 102 completes 224 the task; and responsive to user input indicating a command to not continue, the automatic task manager agent 102 discontinues the task.

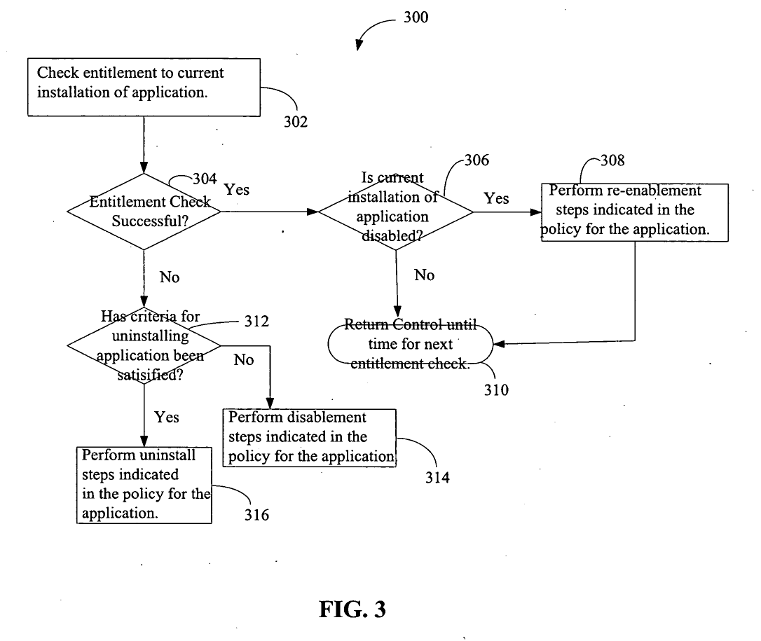

FIG. 3 is a flow diagram of a method for automated distributed management in a local area networks of entitlement to an application in accordance with a policy downloaded from the Internet in accordance with an embodiment of the present invention. For illustrative purposes only and not to be limiting thereof, the method embodiment 300 FIG. 3 is discussed in the context of the system embodiment of FIG. 1. The automatic task manager agent 102 checks 302 entitlement to a current installation of an application on its network node. Responsive to verifying 304 entitlement, the automatic task manager agent 102 determines 306 whether the current installation is currently disabled, and if currently disabled, performs 308 re-enablement steps indicated in a policy for the application. If the current installation is not currently disabled, the automatic task manager agent 102 returns 310 control to another task or program until the time for the next scheduled entitlement check.

Responsive to entitlement not being verified, the automatic task manager agent 102 determines 312 whether criteria for uninstalling the application has been satisfied. Responsive to criteria for uninstalling the application being satisfied, the automatic task manager agent 102 performs 316 steps for uninstalling the application included in the policy, and responsive to criteria for uninstalling the application not being satisfied, performing 314 steps in the policy for disabling the installment of the application.

FIG. 4 illustrates examples of different bandwidth consumption rates for a number of download speeds in accordance with an embodiment of the present invention. The automatic task manager agent 102 is capable of downloading data from the Internet using any of three variable levels of download speeds. In the illustrated examples, the agent 102 can insert a delay of a variable rate between each downloaded data portion 402_{N}, for example 8 KB. The illustrated example delays are a fastest rate of no delay 406, a medium download rate 408 of minimal approximate delays of 0.1 seconds resulting in approximately 40% usage of the available Internet bandwidth usage and a slowest download rate 410 of larger delays of approximately 0.4 seconds resulting in approximately 15% usage of the available Internet bandwidth usage.

In one example of a file size criteria upon which the automatic task manager agent 102 selects a download speed, all policy files which are about 500-700 bytes and other files of this approximate size are downloaded using the fastest rate 406. Image downloads associated with a particular policy file are downloaded using the slowest setting, as these files can be 500 KB to 100 MB in size. By using the slowest setting for these downloads, the image file can be downloaded with negligible impact on the end-user's internet performance, which is particularly important in a desktop computer system.

Since policy files can be downloaded in a single networking packet, reducing the download speed has no effect. By contrast, downloading a 4 MB file using the slowest setting adds nearly 3.5 minutes to the download. For an idle 1.5 Mb DSL connection, this spreads the download evenly over a 4 minute period, rather than consuming all the bandwidth for about 30 seconds.

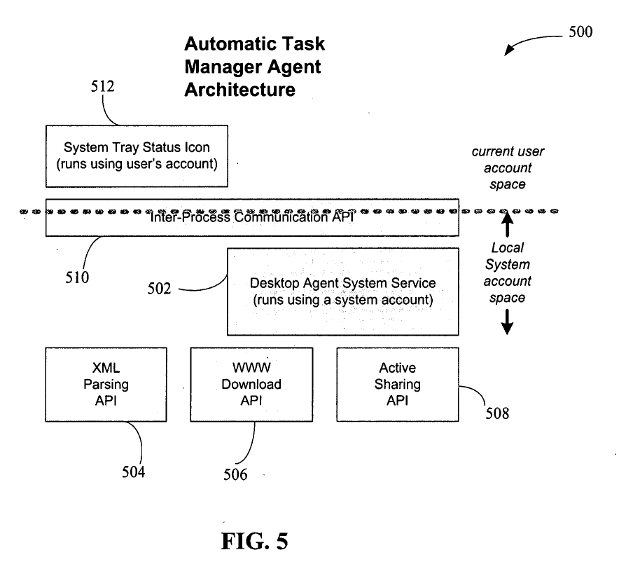

FIG. 5 illustrates an implementation example of a system 500 for automated distributed management in a local area network of application tasks downloaded from the Internet comprising a first executable operating as a system service and a second executable operating in user space in accordance with an embodiment of the present invention. The automatic task manager desktop agent system service 502 is the principal executable which operates persistently as a system service and performs the majority of the work. As a system service account in the local system account space, this account runs with administrative privileges granted by the operating system to all services. The secondary executable 512 including a system tray status icon communicates information to the end user and operates in the current user's account space. In this implementation example, the second executable 512 is responsible for manipulating a status icon on a user's desktop display and runs in the current user's account space whenever the current user is logged in.

The automatic task manager agent 102 has been implemented using several components, including reusable library modules for common, complex operations (such as communicating with the internet). To communicate with each other (for such purposes as tracking user login hours, task result availability, and configuring the internet), an Inter-Process Communication (IPC) application programming interface (API) is provided for passing messages between the two (discrete) process spaces of system account space and user account space. This library provides a simple message-passing mechanism used by the two program executables.

To download files and browse web folders, a web download API 506 is provided. This library greatly simplifies the tasks of scanning a web folder and downloading a web resource, either into a file or directly into memory. It also implements the variable download speed capability described earlier.

Also provided is an XML parsing API 504. This library provides an in-memory implementation of the contents of an XML input file. It further provides support for searching in-memory representations for named elements and for creating XML data and storing it in a text file. Finally, it provides an alternate, optimized, binary form of XML data that greatly reduces the amount of processing needed to read an XML file.

Many desktop computers use Windows which provides no internet configuration for any user account. Ordinarily, these settings are established (interactively) when the user first connects to the internet. Since it is not possible for the account 502 used with system services to be used interactively, there is no way to set up these values for the system service. Since the user must have access to the Internet in order to download and install the automatic task manager agent 102, the proper internet settings are known at the time of installation.

When the automatic task manager agent 102's system service first runs, it checks its internet settings. If they are not yet set, the system service sends a message to the status icon program (using its IPC API 510) requesting the current Internet settings. The status icon program 512 then captures its own settings (which are not visible to other user accounts) and stores them into an XML file. Once the file is ready, the status icon program sends a message back to the system service announcing that the settings file is available. The system service then reads the XML file and sets its own internet values as indicated in the file.

By default, all scheduled tasks are run from the local system's account space. The local system account is an administrative account (for Windows) used by default by each system service. This account does not have access to many of the current (logged-in) user's resources. The logged-in user's credentials would be required in order for a service to impersonate that user.

To get around the need for credentials, a scheduled task can create an intermediate script file that creates a task result file to perform the actual work. The task result file specifies “IMMEDIATE” for its summary value and the command string for the work to be performed. Note that only one task can be performed at a time using this mechanism. The task that runs immediately can create another task result file to communicate its results to the end user in the same manner as other scheduled tasks. Because this task is launched by the status icon program in the logged-in user's space, the task will now have access to all of the user's resources. There is no guarantee, however, that the logged-in user will have administrative rights on the machine, so this work around may not work for every task. If the user is not logged in at the time that the task result file is created, the “immediate” task will be run when the user next logs in.

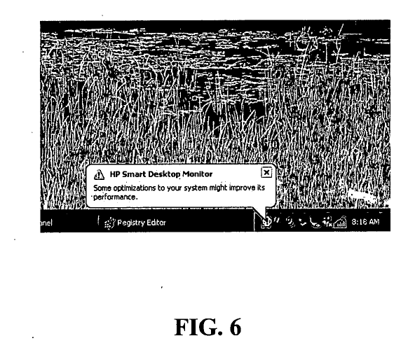

FIG. 6 illustrates an example display for notifying an end user about a task result in accordance with an embodiment of the present invention.

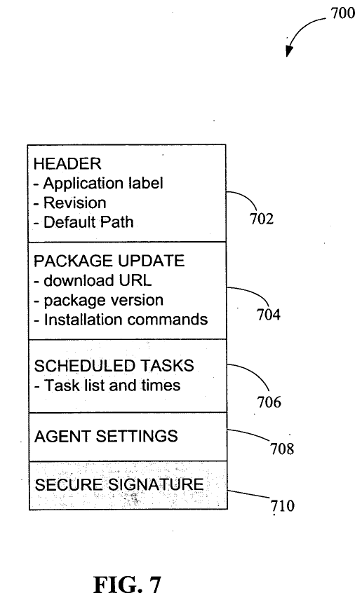

FIG. 7 illustrates an example of a policy file format 700 that can be used in one or more embodiments of the present invention. Each policy file is specified using the extensible markup language (XML). The policy file contains sections for a header, package update information, scheduled tasks, application-specific settings, and a signature value. All the tags below should be enclosed within a root tag, for example:
<POLICY> . . . </POLICY>.
The header contains the application's label (used to associate scheduled tasks with the application), the policy file's revision sequence number, and the application's default path on the system. The path can be specified as a value read from a Windows registry or as an absolute string (with environment variable substitutions).

The package update information includes the URL of a package file to be downloaded, the (expected) version of the download file, and a sequence of steps to perform once the file has been successfully downloaded. The steps may include registry settings and commands, each executed in the order it appears in the policy file.

The scheduled tasks section lists each scheduled task that is expected to be run by the Automatic task manager agent 102 on a periodic basis (or just once). Tasks can be launched on any day of the week, and the days may be combined. A shorthand is provided for tasks that need to run every day (daily) and tasks that need to run Monday through Friday (workdays or m_f). The time of day can be specified as a specific time (e.g., 11:23 pm), the number of minutes since midnight, or as a random time of day. The random time is selected once when the policy file is first processed.

In addition to the start time, each scheduled task may indicate that it is to be launched just once. Any task so marked will be removed from the task database upon its completion. A task may also indicate a result file to be created. Listing the result file in the task definition improves the responsiveness of the automatic task manager agent 102 to present the message to the end user.

Each policy file is “signed” to protect against tampering. In one example to create a signature value, place an empty signature tag in the policy file and process the file using the command MAKESIG.EXE 190, which will compute the proper signature value and store it in the tag. Only text that precedes the signature tag is protected by the signature. Because of this, any entries that occur past the signature tag will be ignored in the calculation.

Each policy file may contain application-specific settings along with the policy information. The Automatic task manager agent 102 has its own policy file which contains operating settings used by the agent. Settings should be enclosed within a <SETTINGS> tag. The following values may be set in the agent's policy file. Only a policy file using the agent's application label can contain settings that will affect the agent. The automatic task manager agent 102 will ignore the settings section from all other policy files.

To communicate task results to the end user, a scheduled task creates a task result file in a designated directory (e.g., a directory for the task result files 122 under the automatic task manager agent installation directory.) The result file contains the application label (matching the policy file that contains the scheduled task), a summary status, and a message to be displayed to the end user. It may also contain a command to be launched when the end user responds to the message, and a default path to use for the command. The following is an example of a result file:

```
<?xml version=“1.0” encoding=“UTF-8”?>
<RESULTS>
  <LABEL>My application</LABEL>
  <SUMMARY>INFORMATION</SUMMARY>
  <MESSAGE>Your system has been acted upon to your
  satisfaction.</MESSAGE>
  <ACTION>IEXPLORE.EXE http://www.hp.com/
  survey.html</ACTION>
</RESULTS>
```

In one example for a Windows desktop display, the task result file may include any of four recognized summary values:
INFORMATIONAL=a blue icon, important information for the user
WARNING=a yellow icon, the user's attention is required promptly
FAILURE=a problem has been detected and should be remedied
IMMEDIATE=launch the indicated task without informing the user

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the hereto appended claims. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three.

Of course, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

What is claimed is:

1. A system for automated distributed management of application tasks downloaded from the Internet in a local area network comprising:
an automatic task manager software agent operating on a network node in the local area network communicatively coupled via the Internet for downloading at least one policy with a scheduled task from an application service and generating a task result file for the at least one policy for launch in a logged-in user's space; and
a memory including a policy database accessible to the automatic task manager for storing the at least one downloaded policy, and a storage module for storing the at least one task result file.

2. The system of claim 1 wherein the automatic task manager is communicatively coupled to a neighborhood sharing module through which the automatic task manager shares a downloaded policy with at least one other automatic task manager operating on a sharing node in a sharing neighborhood via the local area network.

3. The system of claim 1 wherein the automatic task manager comprises:
a first executable operating as a system service which runs with administrative privileges granted by an operating system of the network node; and
a second executable for manipulating a status icon responsive to the at least one task result file in the logged-in user's space.

4. The system of claim 1 wherein the automatic task manager agent selects a download speed level for data from the Internet from a plurality of speed levels based on a file size criteria.

5. The system of claim 1 wherein
the automatic task manager periodically performs an entitlement check for verifying whether a user has rights to run a current installation of an application; and
wherein the at least one downloaded policy further comprises a sequence of steps to disable an application when an entitlement check fails, and
a sequence of steps to re-enable an application when an entitlement check validates entitlement has been restored.

6. The system of claim 5 wherein the at least one downloaded policy further comprises a sequence of steps for uninstalling an application responsive to the automatic task manager being unable to verify entitlement for a predetermined time period.

7. A method for automated distributed management in a local area network of applications tasks downloaded from the Internet comprising:
automatically determine at a predetermined time whether a new or update policy is available from an application service via the Internet;
responsive to a new policy being available, downloading the new policy into a local policy database and downloading any new image file as indicated in the policy file and install it as directed in the policy file; and
responsive to an updated policy being available, downloading the updated policy and replacing any scheduled task associated with an earlier version of the updated policy with the tasks of the updated policy.

8. The method of claim 7 further comprising:
sharing the available new or update policy with an automatic task manager agent of a sharing neighbor network node in a sharing neighborhood on the local area network.

9. The method of claim 8 further comprising:
responsive to no new or updated policy being available, notify the automatic task manager agent of the sharing neighbor network node.

10. The method of claim 7 further comprising:
launching a task of the downloaded policy according to a start time criteria indicated in the policy;
display task results with a request to continue for an end user;
responsive to user input indicating a command to continue, completing the task; and
responsive to user input indicating a command to not continue, discontinuing the task.

11. The method of claim 7 further comprising:
checking entitlement to a current installation of an application;
responsive to verifying entitlement, determining whether the current installation is currently disabled, and if currently disabled, performing re-enablement steps indicated in a policy for the application;
responsive to entitlement not being verified, determining whether criteria for uninstalling the application has been satisfied;
responsive to criteria for uninstalling the application being satisfied, performing steps for uninstalling the application included in the policy; and
responsive to criteria for uninstalling the application not being satisfied, performing steps in the policy for disabling the installment of the application.

12. A system for automated management of application tasks downloaded from the Internet in a distributed management local area network comprising:
means for automatically determine at a predetermined time whether a new or update policy is available from an application service via the Internet;
responsive to a new policy being available, means for downloading the new policy into a local policy database; and
responsive to an updated policy being available, means for downloading the updated policy and replacing any scheduled task associated with an earlier version of the updated policy with the tasks of the updated policy.

13. A computer usable medium comprising software for causing a processor to execute a method for automated management of application tasks downloaded from the Internet in a distributed management local area network, the method comprising:
checking entitlement to a current installation of an application in accordance with a task of a policy downloaded from a server of a service supporting the application via the Internet;
responsive to verifying entitlement, determining whether the current installation is currently disabled, and if currently disabled, performing re-enablement steps indicated in a policy for the application;
responsive to entitlement not being verified, determining whether criteria for uninstalling the application has been satisfied;
responsive to criteria for uninstalling the application being satisfied, performing steps for uninstalling the application included in the policy; and
responsive to criteria for uninstalling the application not being satisfied, performing steps in the policy for disabling the installment of the application.
